(19) United States
(12) Patent Application Publication
(10) Pub. No.: US 2014/0056011 A1
(43) Pub. Date: Feb. 27, 2014

(54) MANUALLY PORTABLE ILLUMINATING DEVICE SUITABLE FOR WARNING SIGNAL

(71) Applicants: PARLEY A. CLEMENT, KENNEWICK, WA (US); ALTON B. OTIS, JR., PORT TOWNSEND, WA (US)

(72) Inventors: PARLEY A. CLEMENT, KENNEWICK, WA (US); ALTON B. OTIS, JR., PORT TOWNSEND, WA (US)

(21) Appl. No.: 13/766,544

(22) Filed: Feb. 13, 2013

Related U.S. Application Data
(63) Continuation-in-part of application No. 12/553,934, filed on Sep. 3, 2009, now Pat. No. 8,393,750.

(51) Int. Cl. F21L 4/04; F21V 23/04

(52) U.S. Cl. CPC F21L 4/04; F21V 23/0464; F21V 23/0407
USPC 362/464; 362/183

(57) ABSTRACT

An extendable and/or retractable illuminating device comprises a luminaire atop a telescoping mast, which is selectively positionable between extended and retracted positions, suitable for use as a warning signal. The luminaire has a strobe feature and its intensity is capable of automatic adjustment in response to ambient light levels. The telescoping mast, and thus the luminaire, are driven by an electric motor within a manually portable case, which also houses a rechargeable electrical power supply and microcontroller unit for providing power and operating commands to the luminaire.

### PRIORITY/CROSS-REFERENCE TO RELATED APPLICATIONS

This application is a continuation-in-part application of application Ser. No. 12/553,934, filed Sep. 3, 2009, which is pending, and the disclosure of which is incorporated herein by this reference.

### BACKGROUND

The disclosure relates to an extendable and/or retractable, or telescoping, light to provide an easily viewed warning signal. Particular embodiments relate to warning signals associated with single occupancy, slow-moving vehicles and warning signals associated with emergency scenes.

Small, single-occupancy vehicles, such as wheelchairs and all terrain vehicles are often found in traffic where they are not as visible as automobiles or other motorized vehicles. This visibility problem is exacerbated in low-light or night-time conditions. Additionally, auto accident scenes pose hazards to traffic and are frequently marked with warning flares having a limited burn time. The present disclosure is directed at a solution to these and other scenarios where a portable, versatile warning light is useful.

### BRIEF SUMMARY

Disclosed here is an extendable and/or retractable illuminating device that comprises a manually portable case connected to a luminaire by way of a telescoping mast. The mast, and thus the luminaire, is selectively positionable between an extended position and a retracted position such the luminaire may be raised and lowered according to a user control. The luminaire comprises one or more LEDs and is controlled by one or more microcontroller units. The output of the luminaire is capable of automatic adjustment to compensate for ambient light conditions. The device is powered by a self-contained rechargeable electrical power supply. A drive motor within the case portion operates a drive rod for positioning the telescoping mast and thus the luminaire. The device is capable of user control with a local or a remote control.

The disclosed device is particularly adaptable for use as warning light for single-occupancy, slow-moving vehicles. It is also adaptable for use as a warning light for emergency scenes, especially those associated with incidents on or near highways and roads.

### BRIEF DESCRIPTION OF THE DRAWINGS

FIG. 1 is a perspective view of the disclosed extendable and/or retractable illuminating device with exploded subassemblies.

FIG. 1A is a perspective view of the disclosed extendable and/or retractable illuminating device with luminaire in a retracted position.

FIG. 1B is a perspective view of the disclosed extendable and/or retractable illuminating device with luminaire in an extended position.

FIG. 2 is a partially exploded perspective view of a case subassembly of the disclosed extendable and/or retractable illuminating device.

FIG. 3 is an exploded perspective view of a case subassembly of the disclosed extendable and/or retractable illuminating device.

FIG. 3A is a sectional view taken about the line A-A in FIG. 3.

FIG. 3B is a sectional view taken about the line B-B in FIG. 3.

FIG. 4 is an exploded perspective view of a luminaire subassembly of the disclosed extendable and/or retractable illuminating device.

FIG. 5 is a perspective view of the disclosed extendable and/or retractable illuminating device mounted on a wheelchair.

FIG. 6 is a block diagram depicting a method of operation of the disclosed extendable and/or retractable illuminating device.

### DETAILED DESCRIPTION

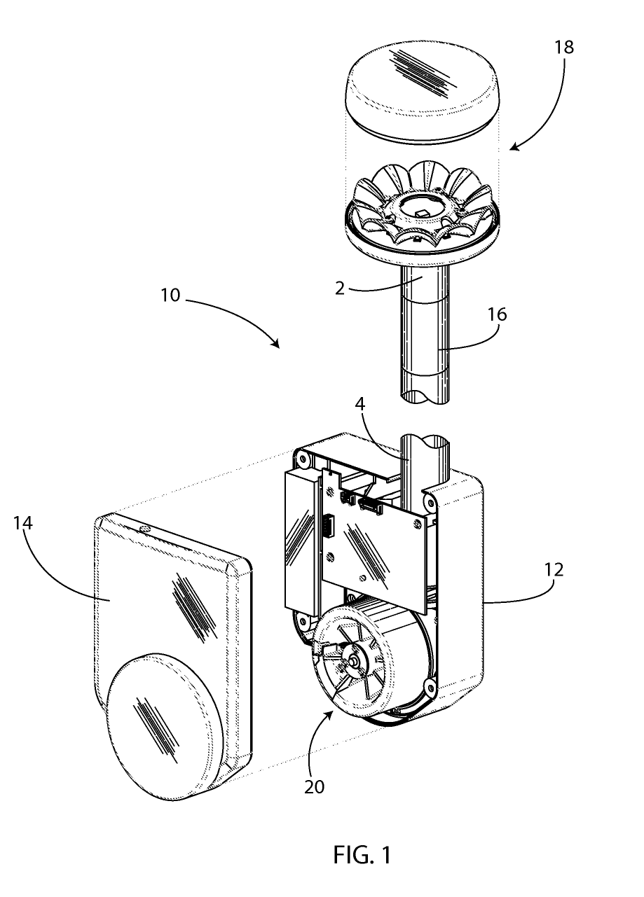

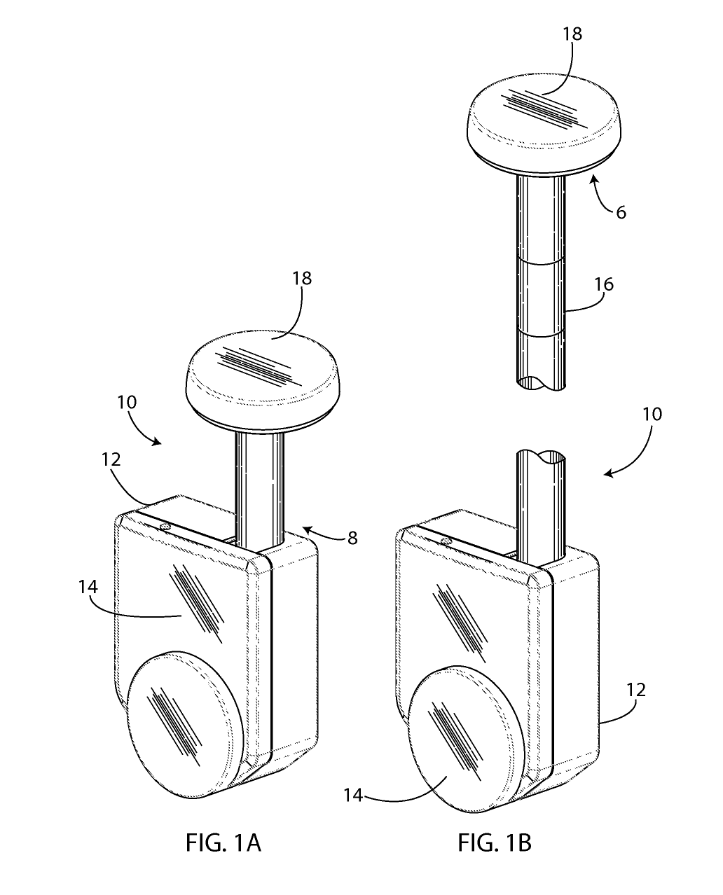

FIGS. 1 through 5 illustrate an extendable and/or retractable illuminating device assembly 10 shown with a manually portable case 12 with a case cover 14. A manually portable case 12 is a case that is constructed of a size and out of materials such that it is readily carried by a person of average strength and ability. The manually portable case 12 and cover 14 will generally be constructed of a rigid material including metal, plastic, composite, wood, or similarly suitable material. The cover 14 is fastened by screws, bolts, or snaps, or hinged, or otherwise connected to the case 12 by a means recognized by those of ordinary skill in the case arts such that the cover 14 is capable of opening to reveal, and closing to conceal the contents of the case. It is recognized, by those of ordinary skill in the mechanical and container arts, that there will be many containers with various configurations, including different means of access, and constructed of generally rigid materials that will provide for a suitable case.

As best seen in FIG. 1, a tubular telescoping mast 16, with a distal end 2 and an attachment end 4 extends outwardly from the case 12, and is attached to the case at the attachment end 4 of the telescoping mast 16. At the distal end 2, the telescoping mast 16 is fitted with a luminaire 18. The luminaire 18 is selectively positionable between an extended position 6 (FIG. 1A) and a retracted position 8 (FIG. 1B). In other words, the luminaire 18 may be raised, i.e., extended, or lowered, i.e., retracted, with respect to the case 12.

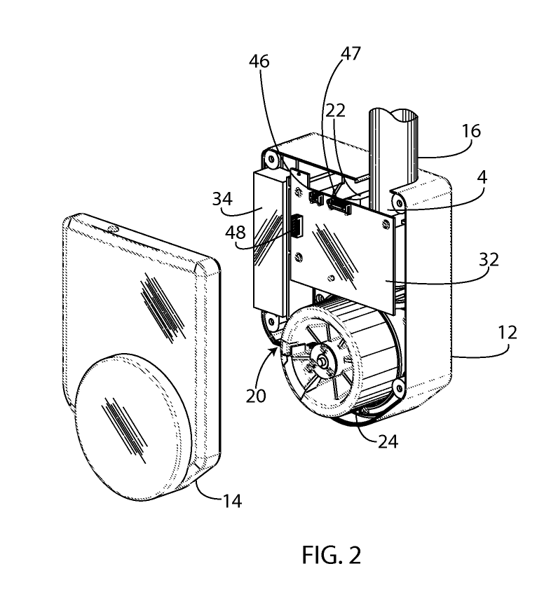

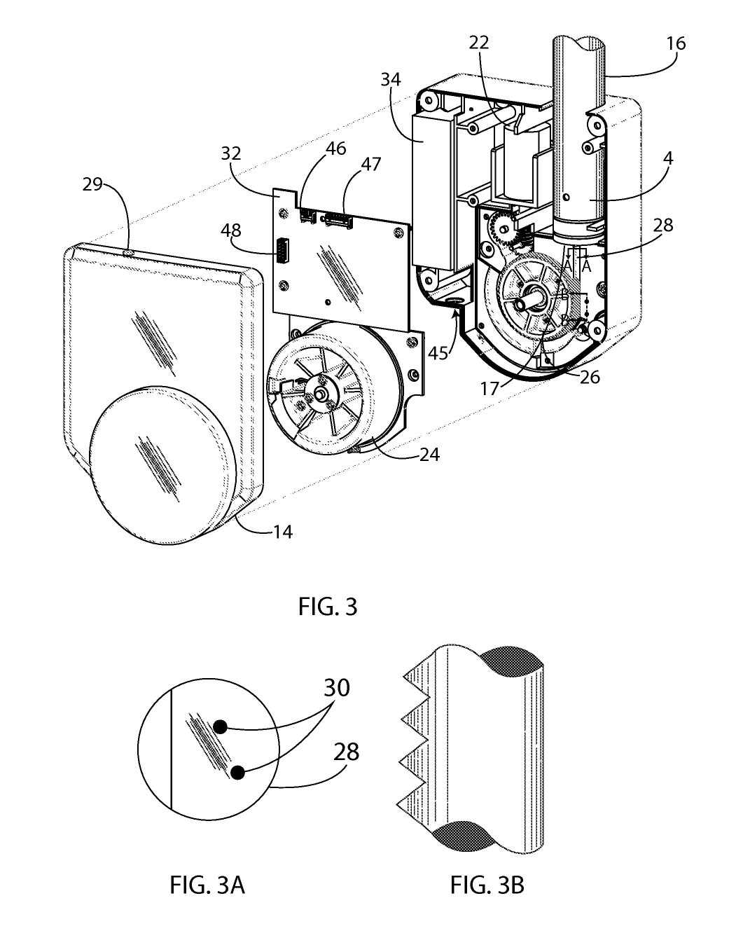

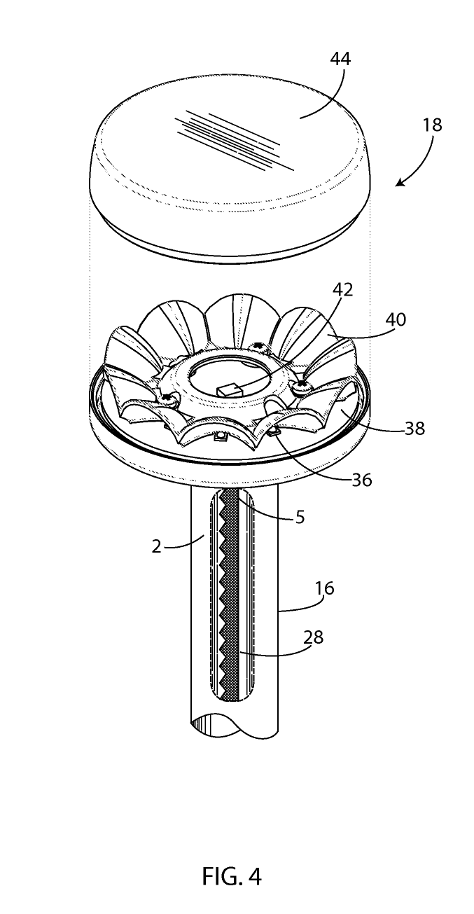

FIGS. 2 and 3 show a drive motor assembly 20 housed in case 12. The drive motor assembly 20 comprises a drive motor 22, a drive rod spool 24, a drive gear 26, and a drive rod 28. The drive rod 28 has two ends and is disposed within the tubular passageway 17 created by the telescoping mast 16. One end of the drive rod 28, the gear end 3, is connected to the drive gear 26, which is connected to and driven by the drive motor 22. The other end of the drive rod 28, the luminaire end 5 (FIG. 4), is connected to the luminaire 18. The drive gear 26 operates the drive rod 28 to extend or retract the telescoping mast 16. The drive gear 26 is configured to spool and unspool the drive rod 28 about the drive rod spool 24 as the drive rod 28 extends and retracts, respectively, the telescoping mast 16. The drive rod 28 is made of material sufficiently rigid such that it can extend the telescoping mast 16 as the drive rod 28 unspools from the drive rod spool 24, and then retract the telescoping mast 16 as the drive rod 28 spools on the drive rod spool 24. The status indicator 29, as discussed infra, may communicate information to the user about problem conditions with the telescoping mast 16.

In the preferred embodiment, and best mode presently known, the drive rod 28 is toothed (FIG. 3B). The teeth of the drive rod 28 mesh with the drive rod gear 26. The drive rod 28 is held against the drive rod gear 26 by an idler wheel and is driven by a gear train within drive motor assembly 20. The drive rod 28 feeds from and into the drive rod spool 24 that rotates as the drive rod 28 feeds from or into it. The drive rod 28 is made of plastic, but could also be made of metal, composite, or other suitable rigid material.

Longitudinally disposed along the drive rod 28 are electrical conductors 30. In the preferred embodiment, the electrical conductors 30 are embedded with the drive rod 28. FIG. 3A shows a cross-sectional view of drive rod 28 with the electrical conductors 24 embedded. The electrical conductors 30 provide a means for electrical communication between the case microcontroller unit 32 and the luminaire 18. The electrical conductors 30 may be made of copper, aluminum, copper-plated steel, or other similarly conductive material. The electrical conductors 30 are electrically isolated from one another.

The case microcontroller unit 32 and rechargeable electrical power supply 34 are also housed within case 12. The rechargeable electric power supply 34 is in electrical communication with the drive motor assembly 20 by way of the case microcontroller unit 32. Likewise, the rechargeable electric power supply 34 is in electrical communication with the luminaire 18 by way of the case microcontroller unit 32. The rechargeable electrical power supply could be charged by either a DC or AC charging unit. In the preferred embodiment, the rechargeable electrical power supply unit 34 is a lithium polymer battery pack that is chargeable by connection to an external charger, which, in turn, may be plugged into a 15/20-amp, 120-volt electrical receptacle. But the rechargeable electric power supply 34 could be any type or combination of rechargeable battery or batteries, a system of ultracapacitors, a system of capacitors, a hybrid system of batteries and capacitors, or any similarly suitable power storage and supply means.

As best seen in FIG. 4, the luminaire 18 comprises at least one light emitting diode (LED) 36, a strobe microcontroller unit 38, at least one reflector 40, at least one ambient light sensor 42, and a protective cover 44. In the preferred embodiment, and best mode presently known, the luminaire 18 is connected to the distal end 2 of the telescoping mast 16 and comprises: a plurality of LEDs 36, a plurality of reflectors 40—one reflector per LED—and an ambient light sensor 42, all of which are mounted atop a strobe microcontroller unit 38 and covered by protective cover 44. In the preferred embodiment, the protective cover 44 is translucent plastic. Those skilled in the art of luminaires will, however, recognize that a protective cover 44 may be provided which comprises suitable materials of varying transparencies.

In the preferred embodiment, the luminaire 18 is provided with a flashing feature wherein a plurality of LEDs 36 flash at the direction of the strobe microcontroller unit 38, creating what is referred to here as a strobe effect. The rate at which the LEDs 36 flash may be programmable and adjustable thus providing for a variable flash rate. The luminaire 18 is also equipped with a variable intensity, i.e., the plurality of LEDs 36 are adjustable to provide brighter or dimmer light output, depending on the situation and in proportion to ambient light conditions. This variable intensity is referred to here as the strobe intensity, which is also controlled by the strobe microcontroller unit 38. The luminaire 18 comprises a ring of ten LEDs 36. Each of the LEDs 36 has an output of about 50 lumens. The LEDs 36 are situated such that the light output radiates out from each of the LEDs 36 and then is reflected into a plane normal to the telescoping mast 16, with a vertical spread of approximately plus-or-minus (+/−) ten degrees, which reflection is accomplished by reflectors 40 within the luminaire 18. The ambient light sensor 42 is situated to “look” vertically through the protective cover 44 of the luminaire 18. In other words, the ambient light sensor 42 senses ambient light directed through the top of protective cover 44. The ambient light sensor 42 is in electrical communication with the strobe microcontroller unit 38, which, in turn, is in electrical communication with the case microcontroller unit 32. The strobe microcontroller unit 38 accepts an electrical signal representative of the ambient light from the ambient light sensor 42, which the strobe microcontroller unit 38 reports to the case microcontroller unit 32.

The case microcontroller unit 32 is programmed with logic such that it incorporates the ambient light level signal into its commands to the strobe microcontroller unit 38 for strobe intensity control. In this way, the strobe intensity corresponds to the ambient light to allow better luminaire visibility in daylight and minimize power consumption at night. Those of ordinary skill in the luminaire arts will be familiar with the proportionality of light output to ambient light. The case microcontroller unit 32 may also be programmed to control the strobe flash pattern, in a pattern that is both effective at providing a warning signal and safe for onlookers. The inter-microcontroller unit communication, i.e., communication between the strobe microcontroller unit 38 and the case microcontroller unit 32, is performed over the electrical conductors 30 embedded in the drive rod 28.

In the preferred embodiment, the disclosed illuminating device is controlled with a pulse-width modulated signal such that the drive motor 22 maintains a constant speed as the rechargeable electrical power supply 34 voltage changes allow the telescoping mast 16 to appear to raise at the same speed at any time. The preferred embodiment incorporates over-current detection and timing to detect the raised and lowered—that is, the extended and retracting—limits of the telescoping mast 16 and to detect a partial slowdown of the telescoping mast 16 as it is extended or retracted, which slowdown may be due to obstacles in the path of the luminaire 18 or because of friction build-up within the telescoping mast 16.

In the preferred embodiment, electrical conductors 30 are in electrical communication with the case microcontroller unit 32, within the drive motor assembly 20, via a slip ring mechanism. The slip ring mechanism is not depicted in the drawings, but slip rings are a well-known to those skilled in the electrical arts. The case microcontroller unit 32 controls the speed and direction of drive motor 22. The case microcontroller unit 32 is in electrical communication with the strobe microcontroller unit 32 via electrical conductors 30. Furthermore, the case microcontroller unit 32 monitors the drive motor 22 current consumption, the ambient light sensor 42, the rechargeable electrical power supply 34, and whether a charger is present.

A charger port 45 is provided to connect the battery charger. The charger port is in electrical communication with a first power jack 46 to facilitate charging of the rechargeable electrical power supply 34 and to provide a power connection to the case microcontroller unit 32. Also provided is a second power jack 47 to provide a power connection to the drive motor 22. The case microcontroller unit 32 is also equipped with at least one data port 48, and control logic to monitor the data port 48. The data port 48 allows for manufacturer communication with, and firmware updates of, the case microcontroller unit 32.

In the preferred embodiment, the status indicator 29 is an LED with a refractive lens that provides for easy visibility from all angles. The status indicator 29 may operate to communicate a number of conditions to a user, including: a low battery, an obstructed mast, a request for remote control synchronization, or a condition requiring manufacturer servicing. Such conditions may be conveyed using various sequences of flashes, with each sequence corresponding to a particular condition. For example, a repeating flash of short duration, like 200 ms, could indicate low battery condition. A repeating sequence of a short flash (200 ms) followed by a long flash, like 400 ms, could indicated that the user needs to synchronize the remote control unit. A sequence of one long flash, three short flashes, and a long flash could indicate that the illuminating device has an uncorrectable error and should be returned to the manufacturer for servicing.

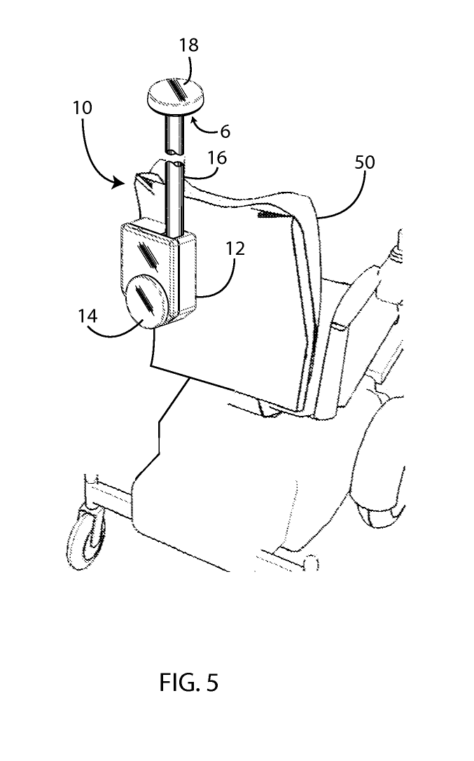

A user may communicate with the case microcontroller unit 32, and thus control the disclosed apparatus, via a remote control, which may be attached to a lanyard and worn by the user as a pendant; or the remote control may be attached, for example, to a wheelchair 50 (FIG. 5) with a hook and loop closure patch or other similar means. In the preferred embodiment, the remote control, which is not shown in the drawings, communicates with the case microcontroller unit 32 via a packet radio means using the FCC-license-free 2.4 GHz band. The remote control is factory-programmed such that it communicates with only a single device. The remote control has a single button that when depressed communicates with the case microcontroller unit 32. The remote control may be provided with an ergonomic design that encourages a user to hold the remote control in a manner that does not obstruct the internal antenna and thus facilitates communication.

In one embodiment, the illuminating device assembly 10 is mechanically connected to a wheelchair 50, as seen in FIG. 5, with no electrical connection between the illuminating device assembly 10 and the wheelchair 50. In such an embodiment, the illuminating device assembly 10 is powered by rechargeable electrical power supply 34, not the wheelchair 50 or a battery that may be connected to the wheelchair 50.

In another embodiment, the case 12 is equipped with a handle for ease of portability, as is disclosed in application Ser. No. 12/553,934, to which this application claims benefit. The handle is connected to the top of the case 12. The handle could be made of any material suitable for the case 12. In such an embodiment, the illuminating device assembly 10 may be used at an emergency location, for example, in lieu of roadside flares. The rechargeable electrical power supply 34 is has a run time that would exceed the normal burn time of a roadside flare.

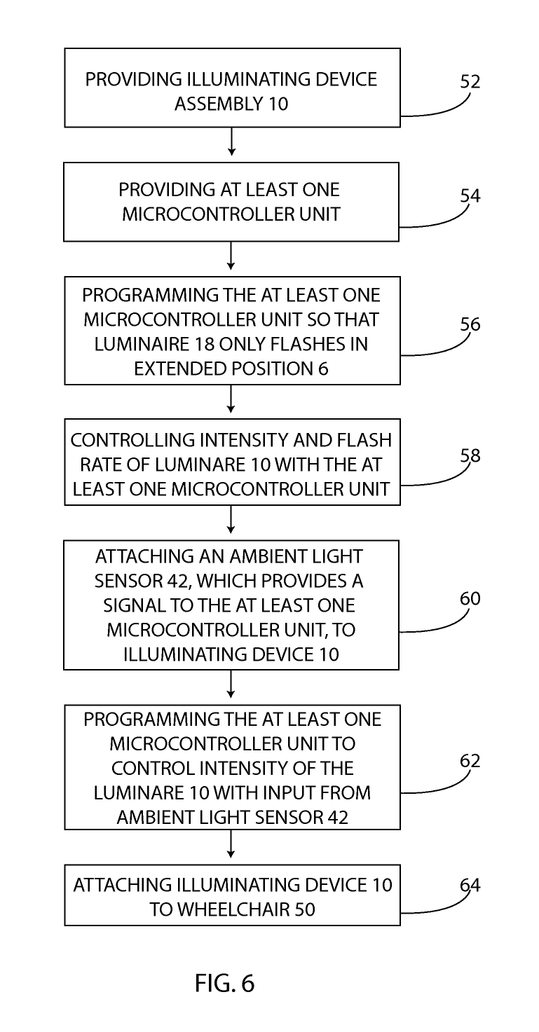

FIG. 6 depicts a method of operating the illuminating device assembly 10. The method comprises the steps of providing 52 the illuminating device assembly 10, including providing 54 at least one microcontroller for control of the luminaire of the provided device. The method involves programming 56 the at least one microcontroller such that the illuminating device 10 only emits light when the luminaire 18 is in an extended position 6. Then it involves controlling 58 the intensity and flash rate of the luminaire 18. Then in it involves attaching 60 an ambient light sensor 42 to the disclosed illuminating device 10. Next the method involves programming 62 the at least one microcontroller unit to control the intensity of the luminaire 18 based in part on the signal from ambient light sensor 42. An additional step in the method involves attaching the illuminating device assembly 10 to a wheelchair 50.

While certain exemplary embodiments are shown in the Figures and described in this disclosure, it is to be distinctly understood that the present disclosure is not limited to any particular embodiment but may be variously embodied to practice within the scope of the following claims. From the foregoing description, it will be apparent that various changes may be made without departing from the spirit and scope of the disclosure as defined by the following claims.

What is claimed is:

1. A manually portable, retractable illuminating device, said illuminating device comprising:
a manually portable case;
a tubular telescoping mast, having a distal end and an attachment end, affixed at said attachment end to said manually portable case, said telescoping mast selectively positionable between an extended position and a retracted position, and defining a tubular passageway from said attachment end to said distal end, for extending or retracting a luminaire;
said luminaire attached to said distal end of said telescoping mast, said luminaire comprising a strobe microcontroller unit, at least one LED, and an ambient light sensor, said strobe microcontroller unit for communicating with said ambient light sensor and said at least one LED;
a rechargeable electrical power supply positioned within said manually portable case and in electrical communication with said luminaire, said power supply for powering said illuminating device;
a drive motor in electrical communication with said power supply, said drive motor within said manually portable case for operating a drive gear;
said drive gear mechanically connected to a drive rod for extending and retracting said telescoping mast;
said drive rod having a gear end and a luminaire end and a plurality of electrical conductors longitudinally disposed along said drive rod from end to end, said drive rod mechanically connected to said drive gear at said gear end and mechanically connected to said luminaire at said luminaire end, said drive rod longitudinally disposed within said tubular passageway of said telescoping mast for extending and retracting said telescoping mast;
a drive rod spool sized to accommodate said drive rod within said case;
said drive gear and drive rod spool configured such that said drive rod spools about said drive rod spool as said drive gear operates said drive rod to retract said telescoping mast;
a case microcontroller unit positioned within said manually portable case for controlling said drive motor and for communicating with said strobe microcontroller unit;
said case microcontroller unit in electrical communication with said drive motor;
said case microcontroller unit in electrical communication with said strobe microcontroller unit by way of said electrical conductors; and
a remote control for wireless communication with said case microcontroller unit.

2. The manually portable, retractable illuminating device of claim 1 wherein said luminaire has a strobe intensity that is proportional to the ambient light as determined by said ambient light sensor.

3. The manually portable, retractable illuminating device of claim 1 wherein said rechargeable electrical power supply is a battery, said battery capable of recharging by an external charger.

4. The manually portable, retractable illuminating device of claim 1 wherein said case microcontroller unit is configured to control said drive motor at a constant speed regardless of a change in voltage of said rechargeable electrical power supply.

5. The manually portable, retractable illuminating device of claim 1 wherein said case microcontroller unit is configured to monitor: operating characteristics of said drive motor, ambient light as reported by said ambient light sensor, voltage of said rechargeable electrical power supply, and a connection with an external charger.

6. The manually portable, retractable illuminating device of claim 1 wherein said luminaire comprises a plurality of LEDs and a plurality of reflectors arranged in a ring, said reflectors oriented to reflect LED output light in a plane generally normal to said telescoping mast.

7. The manually portable, retractable illuminating device of claim 1 wherein said remote control is a user-wearable pendant.

8. A method of operating a manually portable, retractable illuminating device, said method comprising the following steps:
(a) providing a manually portable, retractable illuminating device having a luminaire with a variable intensity and a variable flash rate for providing a visual warning signal;
(b) providing at least one microcontroller unit for control of said luminaire;
(c) programming said at least one microcontroller unit so that said luminaire only flashes when it is in an extended position;
(d) controlling said intensity and flash rate of said luminaire with said at least one microcontroller unit;
(e) attaching to said illuminating device an ambient light sensor that provides at least one control signal to said at least one microcontroller unit; and
(f) programming said at least one microcontroller unit to control said intensity of said luminaire based in part on said control signal from said ambient light sensor.

9. The method of claim 8 wherein said manually portable, retractable illuminating device is the apparatus of claim 1.

10. The method of claim 8 comprising an additional step of attaching said manually portable, retractable illuminating device to a wheelchair to provide a warning signal.
